(19) United States
(12) Patent Application Publication
(10) Pub. No.: US 2026/0001200 A1
(43) Pub. Date: Jan. 1, 2026

(54) SWING STRUCTURE OF RATCHET WRENCH

(71) Applicant: Chih-Min CHANG, CHANGHUA COUNTY (TW)

(72) Inventor: Chih-Min CHANG, CHANGHUA COUNTY (TW)

(21) Appl. No.: 18/922,874

(22) Filed: Oct. 22, 2024

(30) Foreign Application Priority Data
Jun. 28, 2024 (TW) 113124343

(51) Int. Cl. B25B 23/00; B25B 13/46

(52) U.S. Cl. CPC B25B 23/0028; B25B 13/46

(57) ABSTRACT

A swing structure of a ratchet wrench includes a first connector, a second connector, and a pivotably connecting unit. The first connector has two first wing portions, and a first tightening portion. Each first wing portion has a first connecting hole. The first tightening portion has a first tightening hole. The second connector has two second wing portions, and a second tightening portion. Each second wing portion has a second connecting hole. The second tightening portion has a second tightening hole. The second tightening portion and the first tightening portion of the first connector are disposed opposite to each other to form a gap therebetween. The pivotably connecting unit has pivots for fastening the first connector and the second connector to each other, and a fastener for fastening the first tightening hole and the second tightening hole and being tightened to narrow the gap for fixing the angle.

### BACKGROUND OF THE INVENTION

### 1. Field of the Invention

The present invention relates to a swing structure and more particularly, to a swing structure of a ratchet wrench, which uses a plurality of connectors and pivotably connecting mechanism for the assembly of a dual head ratchet wrench to provide a swing function enabling the operation of the wrench at specific angles in special space, and uses tightening structure to fix the specific angle for making the operating process relatively smoother.

### 2. Description of the Related Art

It is well known that Taiwan's machinery industry is quite developed, and is highly competitive from research and design to maintenance. In various complex mechanical structures, there is often only a narrow space for the operator to perform the work, or there are obstacles near the working position. That makes it difficult for the operator to sleeve a wrench tool onto the workpiece. The operator can only perform the work by change between various angles of holding the wrench tool. If the operator needs to constantly change the operating angle for the wrench tool during the work, it will consume a lot of time.

Currently, there are commercially available wrench tools which are adjustable angularly for different working angles, allowing the operator to perform the work smoothly in various spaces. Taiwan Patent Publication No. M300591 disclosed a wrench angle adjusting structure, which provides an angularly adjustable wrench structure. It has been described in the specification of the patent that when angle adjustment is required, the user only needs to operate a press member to force an engage rod to slide so as to separate from an engage tooth section of a protruding ear portion of a tool head, enabling the tool head arbitrary angle adjustment relative to a handle. When the angle is decided, the engage rod is released and thereby driven by a restoring member to be re-engaged. The operation is improved in convenience and capable of adjustment for various angles. However, the engaged portions of such wrench are liable to be worn and thereby weakened in fixed effect, causing the angle of the wrench to change randomly in practical operation and thereby increase trouble in operation.

Besides, Taiwan Patent Publication No. 1297633 disclosed a wrench structure capable of being bent and fixed. The wrench structure is provided with two bendable portions, and designed with two pivotably connecting mechanisms for the bending of a wrench head and a handle part, which are connected to two ends of a pivotably connecting member, for an appropriate shape, and a rotational adjusting wheel for making an engage member to stretch outward so that an engage portion of the engage member is engaged with teeth of a pivoting block of the wrench head or handle part, so as to fix the adjusted angle of the wrench head and handle part. Although in this prior patent the angle of the wrench is fixed in a teeth engaged manner, its structure is relatively more highly required and needs relatively more components to perform the rotational engagement, and the pivoting block needs to be additionally formed with teeth. That increases the mechanisms and components, thereby having disadvantages of increased structural costs and complex maintenance.

Therefore, the inventor made effort to think about how to provide a structure which can fix the angle of the wrench fast, and can also provide great fixing force so that after the wrench is adjusted to a specific angle, the angle is fixed stably and thereby uneasy to be changed during the work.

### SUMMARY OF THE INVENTION

In view of the fact that the above-described existing angle adjusting structures of wrench tools still have many shortcomings in actual implementation and use, the inventor uses rich professional knowledge and years of practical experience thereof to make an improvement, and creates the present invention accordingly.

It is a primary objective of the present invention to provide a swing structure of a ratchet wrench, and the swing structure is formed by a plurality of connectors and only has to use a pivotably connecting unit as a fixture to fix a ratchet head and a handle, and uses a tightening design to easily fix the wrench at a specific angle, so that this structural design is easy to be operated by an operator and not complicated in structural components.

To attain the above objective, the present invention provides a swing structure of a ratchet wrench, which includes a first connector, a second connector, and a pivotably connecting unit. The first connector has two first wing portions, and a first tightening portion formed between the two first wing portions. The two first wing portions are provided at two ends of the first connector respectively, and each first wing portion is provided with a first connecting hole. The first tightening portion is provided with a first tightening hole. The second connector has two second wing portions, and a second tightening portion formed between the two second wing portions. The two second wing portions are provided at two ends of the second connector respectively, and each second wing portion is provided with a second connecting hole. The second tightening portion is provided with a second tightening hole. The second tightening portion and the first tightening portion are disposed opposite to each other to form a gap therebetween. The pivotably connecting unit has two pivots and a fastener. One of the pivots is inserted in one of the first connecting holes of the first connector, and one of the second connecting holes of the second connector. The other pivot is inserted in the other first connecting hole of the first connector, and the other second connecting hole of the second connector. The fastener is inserted in the first tightening hole of the first connector, and the second tightening hole of the second connector.

In an embodiment of the present invention, the first tightening portion of the first connector protrudes from an inner plane of the first connector. The second tightening portion of the second connector protrudes from an inner plane of the second connector. The first tightening hole or the second tightening hole is provided with an internal thread corresponding to the fastener of the pivotably connecting unit.

In an embodiment of the present invention, the first connector and the second connector are arranged symmetrically. The two first wing portions and the two second wing portions form two accommodating spaces therebetween. A ratchet head and a handle of the ratchet wrench both have a pivotably connecting block. The two accommodating spaces are adapted for accommodating the pivotably connecting block of the ratchet head or the handle of the ratchet wrench. The pivotably connecting block is provided with a pivot hole.

In an embodiment of the present invention, one of the pivots of the pivotably connecting unit is inserted in one of the first connecting holes of the first connector, the pivot hole of the ratchet wrench, and one of the second connecting holes of the second connector. The other pivot is inserted in the other first connecting hole of the first connector, the pivot hole of the ratchet wrench, and the other second connecting hole of the second connector.

The present invention also provides another swing structure of a ratchet wrench, which includes a first connector, a second connector, a third connector, and a pivotably connecting unit. The first connector has a first wing portion, and a first tightening portion formed adjacent to the first wing portion. The first wing portion is provided at an end of the first connector, and the first wing portion is provided with a first connecting hole. The first tightening portion is provided with a first tightening hole. The second connector has a second wing portion, and a second tightening portion formed adjacent to the second wing portion. The second wing portion is provided at an end of the second connector, and the second wing portion is provided with a second connecting hole. The second tightening portion is provided with a second tightening hole. The second tightening portion and the first tightening portion are disposed opposite to each other to form a gap therebetween. The third connector is formed at another end opposite to the first wing portion of the first connector and the second wing portion of the second connector, and provided with a third connecting hole. The pivotably connecting unit has two pivots and a fastener. One of the pivots is inserted in the first connecting hole of the first connector, and the second connecting hole of the second connector. The other pivot is inserted in the third connecting hole of the third connector. The fastener is inserted in the first tightening hole of the first connector, and the second tightening hole of the second connector.

In another embodiment of the present invention, the first tightening portion of the first connector protrudes from an inner plane of the first connector. The second tightening portion of the second connector protrudes from an inner plane of the second connector. The first tightening hole or the second tightening hole is provided with an internal thread corresponding to the fastener of the pivotably connecting unit.

In another embodiment of the present invention, the first connector and the second connector are arranged symmetrically. The first wing portion and the second wing portion form an accommodating space therebetween. A ratchet head or a handle of the ratchet wrench has a pivotably connecting block. The accommodating space is adapted for accommodating the pivotably connecting block. The pivotably connecting block is provided with a pivot hole.

In another embodiment of the present invention, one of the pivots of the pivotably connecting unit is inserted in the first connecting hole of the first connector, the pivot hole of the ratchet wrench, and the second connecting hole of the second connector.

In another embodiment of the present invention, a ratchet head or a handle of the ratchet wrench has two pivotably connecting blocks. The two pivotably connecting blocks form a pivotably connecting space therebetween. The third connector is accommodated in the pivotably connecting space. Each pivotably connecting block is provided with a pivot hole.

In another embodiment of the present invention, one of the pivots of the pivotably connecting unit is inserted in one of the pivot holes of the ratchet wrench, the third connecting hole of the third connector, and the other pivot hole of the ratchet wrench.

In another embodiment of the present invention, the first connector, the second connector and the third connector are formed integrally.

### BRIEF DESCRIPTION OF THE DRAWINGS

FIG. 1 is a schematic view of the appearance of a combination of a first embodiment of the present invention with ratchet heads.

FIG. 2 is an exploded view of the structure of the combination of the first embodiment of the present invention with the ratchet heads.

FIG. 3 is another exploded view of the structure of the combination of the first embodiment of the present invention with the ratchet heads.

FIG. 4 is a schematic view of the appearance of a combination of a second embodiment of the present invention with a ratchet head and a handle.

FIG. 5 is an exploded view of the structure of the combination of the second embodiment of the present invention with the ratchet head and the handle.

FIG. 6 another exploded view of the structure of the combination of the second embodiment of the present invention with the ratchet head and the handle.

### DETAILED DESCRIPTION OF THE INVENTION

The present invention primarily applies a plurality of connectors and a pivotably connecting unit to a ratchet wrench. The plurality of connectors are provided with structures for pivotable connection. The plurality of connectors and a ratchet head or a handle of the ratchet wrench are combined by shafts for pivotable connection into the ratchet wrench having a swing structure.

For the detailed description of the technical features of the present invention, the following embodiments and the accompanying drawings are described hereinafter, but not intended to limit the scope of the present invention in any form.

### First Embodiment

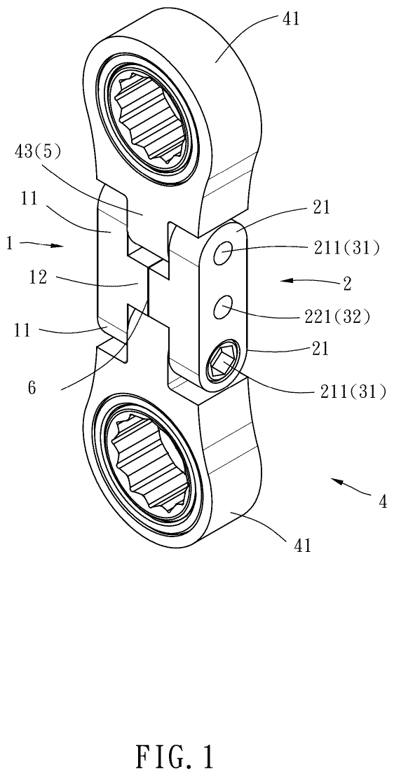

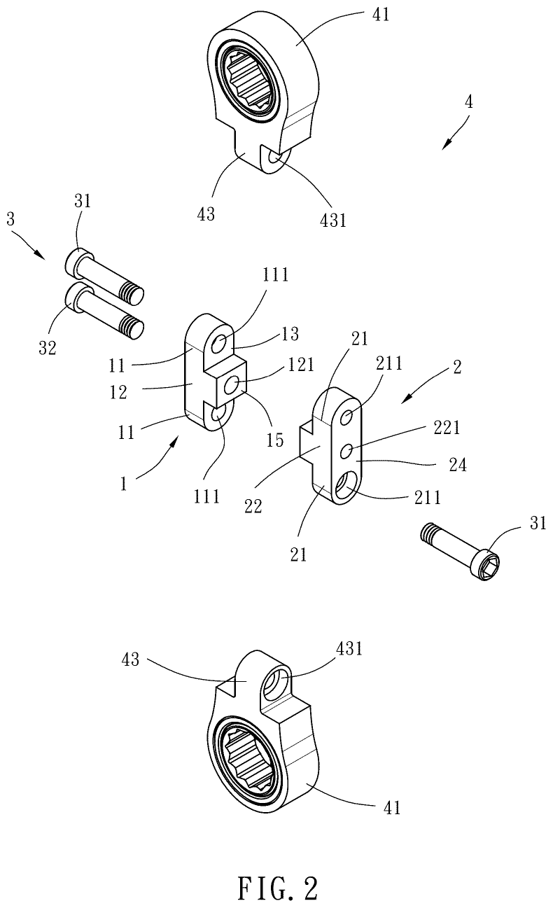

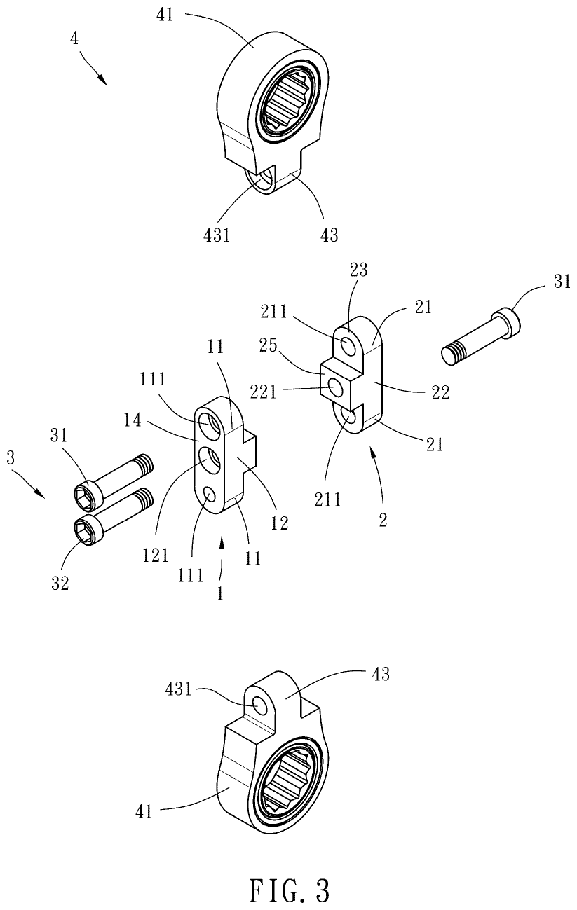

Referring to FIG. 1 to FIG. 3, in the application of the first embodiment of the present invention, a swing structure is primarily composed of a first connector 1, a second connector 2, and a pivotably connecting unit 3. Two ends of the swing structure are combined with ratchet heads 41 of a ratchet wrench 4, so that the dual head ratchet wrench 4 whose heads are both ratchet heads 41 is formed.

In the first embodiment, the first connector 1 is provided at two ends thereof with two first wing portions 11 respectively, and a first tightening portion 12 is formed between the two first wing portions 11. The first tightening portion 12 is located at the middle section of the first connector 1, and protrudes from an inner plane 13 of the first connector 1. The two first wing portions 11 are both provided with a first connecting hole 111 penetrating through an inner plane 13 and an outer plane 14 of the first connector 1. That means the first connector 1 has two first connecting holes 111. The first tightening portion 12 is provided with a first tightening hole 121. The first tightening hole 121 penetrates through the outer plane 14 located on a side of the first connector 1, and a plane 15 of the protruding part.

The second connector 2 is provided at two ends thereof with two second wing portions 21 respectively, and a second tightening portion 22 is formed between the two second wing portions 21. The second tightening portion 22 is located at the middle section of the second connector 2, and protrudes from an inner plane 23 of the second connector 2. The two second wing portions 21 are both provided with a second connecting hole 211 penetrating through an inner plane 23 and an outer plane 24 of the second connector 2. That means the second connector 2 has two second connecting holes 211. The second tightening portion 22 is provided with a second tightening hole 221. The second tightening hole 221 penetrates through the outer plane 24 located on a side of the second connector 2, and a plane 25 of the protruding part.

Besides, the first connector 1 and the second connector 2 are combined with the ratchet head 41 or handle of the ratchet wrench 4 by the pivotably connecting unit 3. The ratchet head 41 and handle are both formed with a pivotably connecting block 43. The pivotably connecting block 43 is provided with a pivot hole 431. The first embodiment is combined with two ratchet heads 41. Before being combined, the first connector 1 and the second connector 2 are arranged symmetrically. The protruding parts of the first tightening portion 12 and the second tightening portion 22 are disposed opposite to each other. The two first wing portions 11 and the two second wing portions 21 correspondingly form two accommodating spaces 5 therebetween. These two accommodating spaces 5 are adapted for accommodating the pivotably connecting blocks 43 of the ratchet heads 41 of the ratchet wrench 4.

The pivotably connecting unit 3 includes two pivots 31 and a fastener 32. During the assembly of the first embodiment, one of the pivots 31 is inserted in the first connecting hole 111 of one of the first wing portions 11 of the first connector 1, the pivot hole 431 of the pivotably connecting block 43 of the ratchet head 41, and the second connecting hole 211 of one of the second wing portions 21 of the second connector 2. The other pivot 31 is inserted in the first connecting hole 111 of the other first wing portion 11 of the first connector 1, the pivot hole 431 of the pivotably connecting block 43 of the other ratchet head 41, and the second connecting hole 211 of the other second wing portion 21 of the second connector 2. The fastener 32 is inserted in the first tightening hole 121 of the first tightening portion 12 of the first connector 1, and the second tightening hole 221 of the second tightening portion 22 of the second connector 2. Meanwhile, the first tightening portion 12 and the second tightening portion 22 form a gap 6 therebetween.

Because the pivots 31 and the fastener 32 in the first embodiment are all bolts, the first connecting hole 111 and the second connecting hole 211 are formed with internal threads corresponding to external threads of the bolts. According to the screwingly fastening direction of the bolt, the internal thread is correspondingly formed in the first connecting hole 111 or the second connecting hole 211. This internal thread is unlimited to be provided in the first connecting hole 111 or the second connecting hole 211. During the assembly, the ratchet heads 41 can be installed through the pivots 31 being screwed on. The middle sections of the bolts can provide the two ratchet heads 41 a degree of freedom for rotation about the axis of the pivot 31, thereby attaining a swing function. According to the requirement for the working space, the ratchet head 41 can be rotated to the required angle for the convenience of performing the work. If the ratchet head 41 has to be replaced by a handle or other tool heads, the user only has to screw off the pivot 31 to remove the existing ratchet head 41 and replace it by the required tool head or handle.

The first tightening hole 121 or the second tightening hole 221 is also formed with an internal thread corresponding to the external thread of the fastener 32. According to the screwingly fastening direction of the bolt, the internal thread is correspondingly formed in the first tightening hole 121 or the second tightening hole 221. This internal thread is unlimited to be provided in the first tightening hole 121 or the second tightening hole 221. When the fastener 32 is not completely tightened, the gap 6 between the first tightening portion 12 and the second tightening portion 22 is relatively larger, and the first wing portions 11 of the first connector 1 and the second wing portions 21 of the second connector 2 are not abutted against the pivotably connecting blocks 43 of the ratchet heads 41, so that the ratchet heads 41 are still angularly changeable. With the tightening of the fastener 32, the first connector 1 and the second connector 2 approach each other. That means the gap 6 between the first tightening portion 12 and the second tightening portion 22 is gradually narrowed, and the distances between the two first wing portions 11 and the two second wing portions 21 become shorter and shorter. At last, the first wing portions 11 and the second wing portions 21 are abutted against the pivotably connecting blocks 43 of the ratchet heads 41 to attain a clamping effect. Meanwhile, the ratchet heads 41 cannot be rotated anymore, so that the adjusted specific angle of the ratchet wrench 4 is fixed. The ratchet heads 41 are prevented from random rotation and the resulting danger during the work.

### Second Embodiment

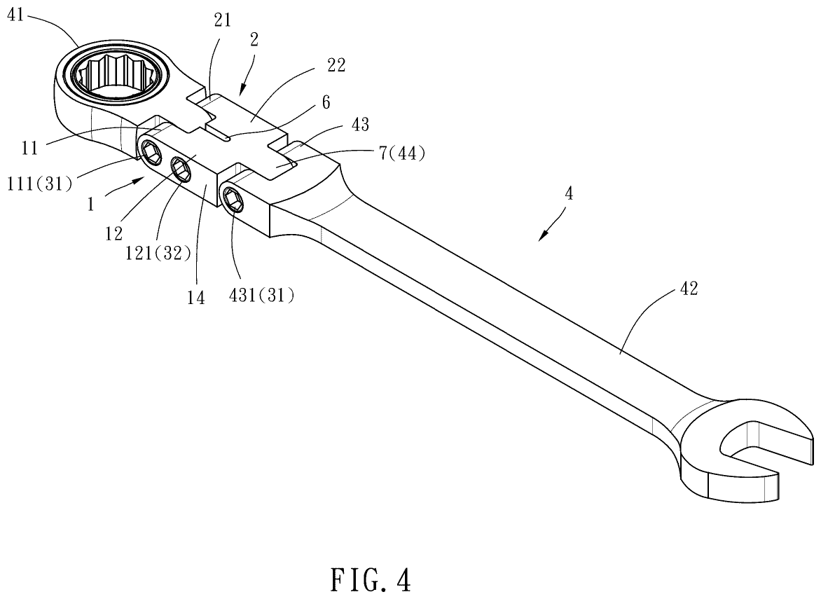

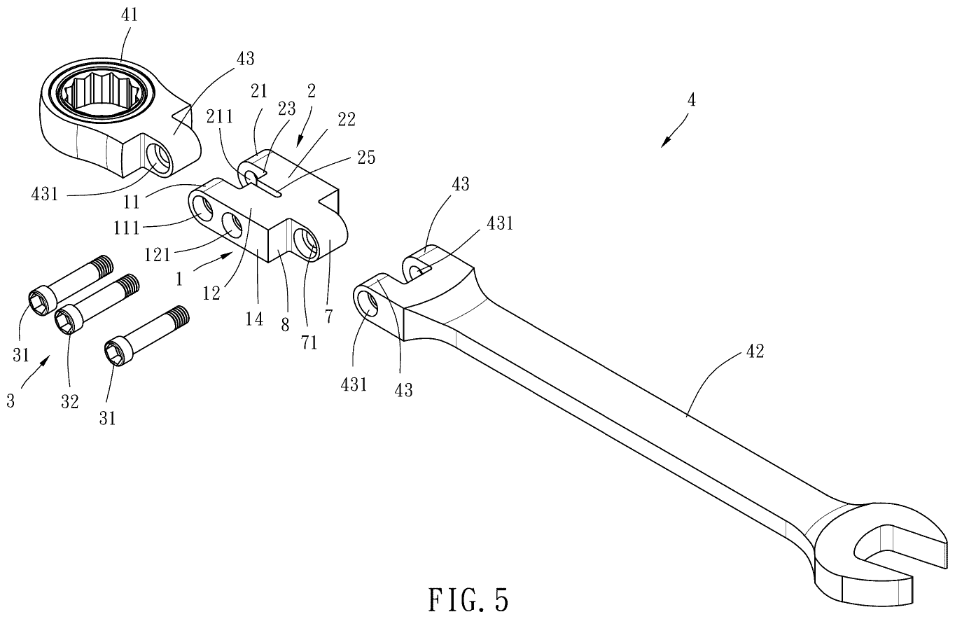

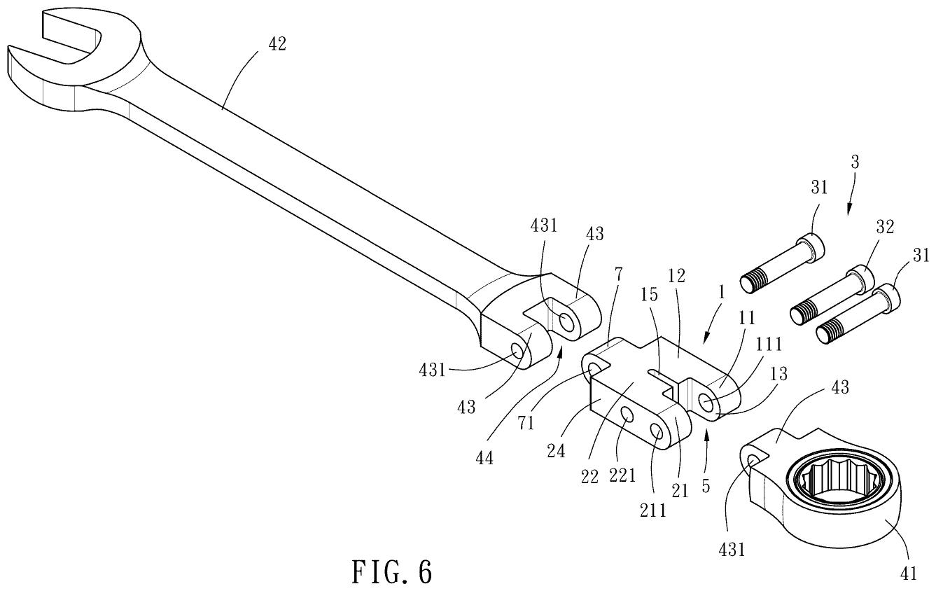

Referring to FIG. 4 to FIG. 6, in the second embodiment of the present invention, the first connector 1 and the second connector 2 are formed integrally, and a third connector 7 is additionally formed. The first connector 1, the second connector 2 and the third connector 7 are combined with the pivotably connecting unit 3 to compose a swing structure. The swing structure of the second embodiment are provided at two ends thereof with different connecting manners for the combination with the ratchet head 41 or handle 42 of the ratchet wrench 4 to compose the ratchet wrench 4.

In the second embodiment, the first connector 1 is provided at an end thereof with a first wing portion 11, and formed with a first tightening portion 12 located adjacent to the first wing portion 11. The first tightening portion 12 is located at the middle section of the first connector 1, and protrudes from an inner plane 13 of the first connector 1. The first wing portion 11 is provided with a first connecting hole 111 penetrating through an inner plane 13 and an outer plane 14 of the first connector 1. The first tightening portion 12 is provided with a first tightening hole 121. The first tightening hole 121 penetrates through the outer plane 14 located on a side of the first connector 1, and a plane 15 of the protruding part.

The second connector 2 is provided at an end thereof with a second wing portion 21, and formed with a second tightening portion 22 located adjacent to the second wing portion 21. The second tightening portion 22 is located at the middle section of the second connector 2, and protrudes from an inner plane 23 of the second connector 2. The second wing portion 21 is provided with a second connecting hole 211 penetrating through an inner plane 23 and an outer plane 24 of the second connector 2. The second tightening portion 22 is provided with a second tightening hole 221. The second tightening hole 221 penetrates through the outer plane 24 located on a side of the second connector 2, and a plane 25 of the protruding part.

The second embodiment further includes the third connector 7 formed on an end plane 8 formed by the first connector 1 and the second connector 2 collectively at the end opposite to the first wing portion 11 of the first connector 1 and the second wing portion 21 of the second connector 2. The third connector 7 protrudes from the end plane 8, and is provided with a third connecting hole 71.

Besides, the first connector 1, the second connector 2, the third connector 7 and the ratchet head 41 or handle 42 of the ratchet wrench 4 are combined by the pivotably connecting unit 3. The ratchet head 41 and the handle 42 is formed with one or two pivotably connecting blocks 43, depending on being combined with the first connector 1, the second connector 2 or the third connector 7. The pivotably connecting block 43 is provided with a pivot hole 431. The second embodiment is combined with a ratchet head 41 and a handle 42. In the second embodiment, the first connector 1, the second connector 2 and the third connector 7 are formed integrally. The first connector 1 and the second connector 2 are arranged symmetrically. The protruding parts of the first tightening portion 12 of the first connector 1 and the second tightening portion 22 of the second connector 2 are disposed opposite to each other to form a gap 6 therebetween. The first wing portion 11 of the first connector 1 and the second wing portion 21 of the second connector 2 correspondingly form an accommodating space 5 therebetween for accommodating the pivotably connecting block 43 of the ratchet head 41 of the ratchet wrench 4. At the other end, the third connector 7 is connected with the handle 42 whose two pivotably connecting blocks 43 form a pivotably connecting space 44 therebetween for accommodating the third connector 7.

The pivotably connecting unit 3 includes two pivots 31 and a fastener 32. During the assembly of the second embodiment, one of the pivots 31 is inserted in the first connecting hole 111 of the first wing portion 11 of the first connector 1, the pivot hole 431 of the pivotably connecting block 43 of the ratchet head 41, and the second connecting hole 211 of the second wing portion 21 of the second connector 2. The other pivot 31 is inserted in the pivot hole 431 of one of the pivotably connecting blocks 43 of the handle 42, the third connecting hole 71 of the third connector 7, and the pivot hole 431 of the other pivotably connecting block 43 of the handle 42. The fastener 32 is inserted in the first tightening hole 121 of the first tightening portion 12 of the first connector 1, and the second tightening hole 221 of the second tightening portion 22 of the second connector 2.

Because the pivots 31 and the fastener 32 in the second embodiment are all bolts, the first connecting hole 111 and the second connecting hole 211 are formed with internal threads corresponding to external threads of the bolts. According to the screwingly fastening direction of the bolt, the internal thread is correspondingly formed in the first connecting hole 111 or the second connecting hole 211. This internal thread is unlimited to be provided in the first connecting hole 111 or the second connecting hole 211. The handle 42 is also correspondingly formed with an internal thread in one of the pivot holes 431 according to the screwingly fastening direction of the bolt. The third connecting hole 71 is provided with no internal thread. During the assembly, the ratchet head 41 and the handle 42 can be installed through the pivots 31 being screwed on. The middle section of the bolt can provide the ratchet head 41 or the handle 42 a degree of freedom for rotation about the axis of the pivot 31, thereby attaining a swing function. According to the requirement for the working space, the ratchet head 41 or the handle 42 can be rotated to the required angle for the convenience of performing the work. If the ratchet head 41 or the handle 42 has to be replaced by other tool heads, the user only has to screw off the pivot 31 to remove the existing ratchet head 41 or handle 42 and replace it by the required tool head.

The first tightening hole 121 or the second tightening hole 221 is also formed with an internal thread corresponding to the external thread of the fastener 32. According to the screwingly fastening direction of the bolt, the internal thread is correspondingly formed in the first tightening hole 121 or the second tightening hole 221. This internal thread is unlimited to be provided in the first tightening hole 121 or the second tightening hole 221. When the fastener 32 is not completely tightened, the gap 6 between the first tightening portion 12 and the second tightening portion 22 is relatively larger, and the first wing portion 11 of the first connector 1 and the second wing portion 21 of the second connector 2 are not abutted against the pivotably connecting block 43 of the ratchet head 41, so that the ratchet head 41 is still angularly changeable. With the tightening of the fastener 32, the first connector 1 and the second connector 2 approach each other. That means the gap 6 between the first tightening portion 12 and the second tightening portion 22 is gradually narrowed, and the distance between the first wing portion 11 and the second wing portion 21 becomes shorter and shorter. At last, the first wing portion 11 and the second wing portion 21 are abutted against the pivotably connecting block 43 of the ratchet head 41 to attain a clamping effect. Meanwhile, the ratchet head 41 cannot be rotated anymore, so that the adjusted specific angle of the ratchet wrench 4 is fixed. The ratchet head 41 is prevented from random rotation and the resulting danger during the work.

In the first embodiment and the second embodiment of the present invention, the angle fixing effect is primarily attained by completely tightening the fastener 32. In addition, if bolts are used to serve as the pivots 31, the pivots 31 can be also completely tightened to fix the ratchet head 41 or the handle 42 at a specific angle, and the fastener 32 is then tightened to increase the fixing force. However, the present invention is unlimited to use bolts as the pivots 31, but may use general pins to serve as the pivots 31 for the ratchet head 41 or the handle 42 to be installed and rotated.

It can be known from the above description of the embodiments that the present invention has the following advantages when compared with the existing technique.
1. The swing structure of the ratchet wrench of the present invention is composed of a plurality of connectors and a pivotably connecting unit, and can fix the ratchet head and the handle of the ratchet wrench. The pivots enable the action of changing the angle. According to the requirement for the working space, the ratchet head or the handle can be rotated to the required angle so that the operator can operate at an appropriate angle in a narrow space.
2. The swing structure of the ratchet wrench of the present invention uses the tightening portions of the connectors to tighten the ratchet head or the handle of the ratchet wrench. Completely tightening the fastener can narrow the gap between the first tightening portion and the second tightening portion, and make the first connector and the second connector approach each other, thereby tightening the pivotably connecting block of the ratchet head or the handle. By simple configuration design and operating manner, the adjusted specific angle of the ratchet wrench can be effectively fixed.

In conclusion, the swing structure of the ratchet wrench of the present invention can indeed attain the expected usage effects through the above disclosed embodiments. However, the above disclosed figures and description are only the preferred embodiments of the present invention. The manners and constituent elements disclosed in the above embodiments are only taken as examples for illustration, not intended to limit the scope of the present invention. The substitution or variation of other equivalent elements should be included within the scope of the following claims of the present invention.

What is claimed is:

1. A swing structure of a ratchet wrench, the swing structure comprising:
a first connector having two first wing portions and a first tightening portion formed between the two first wing portions, the two first wing portions being provided at two ends of the first connector respectively, each of the first wing portions being provided with a first connecting hole, the first tightening portion being provided with a first tightening hole;
a second connector having two second wing portions and a second tightening portion formed between the two second wing portions, the two second wing portions being provided at two ends of the second connector respectively, each of the second wing portions being provided with a second connecting hole, the second tightening portion being provided with a second tightening hole, the second tightening portion and the first tightening portion of the first connector being disposed opposite to each other to form a gap therebetween; and
a pivotably connecting unit having two pivots and a fastener, one of the pivots being inserted in one of the first connecting holes of the first connector and one of the second connecting holes of the second connector, the other pivot being inserted in the other first connecting hole of the first connector and the other second connecting hole of the second connector, the fastener being inserted in the first tightening hole of the first connector and the second tightening hole of the second connector.

2. The swing structure as claimed in claim 1, wherein the first tightening portion of the first connector protrudes from an inner plane of the first connector; the second tightening portion of the second connector protrudes from an inner plane of the second connector; one of the first tightening hole and the second tightening hole is provided with an internal thread corresponding to the fastener of the pivotably connecting unit.

3. The swing structure as claimed in claim 1, wherein the first connector and the second connector are arranged symmetrically; the two first wing portions and the two second wing portions form two accommodating spaces therebetween; a ratchet head and a handle of the ratchet wrench both have a pivotably connecting block; the two accommodating spaces are adapted for accommodating the pivotably connecting block of the ratchet head or the handle of the ratchet wrench; the pivotably connecting block is provided with a pivot hole.

4. The swing structure as claimed in claim 3, wherein one of the pivots of the pivotably connecting unit is inserted in one of the first connecting holes of the first connector, the pivot hole of the ratchet wrench, and one of the second connecting holes of the second connector; the other pivot is inserted in the other first connecting hole of the first connector, the pivot hole of the ratchet wrench, and the other second connecting hole of the second connector.

5. A swing structure of a ratchet wrench, the swing structure comprising:
a first connector having a first wing portion and a first tightening portion formed adjacent to the first wing portion, the first wing portion being provided at an end of the first connector, the first wing portion being provided with a first connecting hole, the first tightening portion being provided with a first tightening hole;
a second connector having a second wing portion and a second tightening portion formed adjacent to the second wing portion, the second wing portion being provided at an end of the second connector, the second wing portion being provided with a second connecting hole, the second tightening portion being provided with a second tightening hole, the second tightening portion and the first tightening portion of the first connector being disposed opposite to each other to form a gap therebetween;
a third connector formed at another end opposite to the first wing portion of the first connector and the second wing portion of the second connector, and provided with a third connecting hole; and
a pivotably connecting unit having two pivots and a fastener, one of the pivots being inserted in the first connecting hole of the first connector and the second connecting hole of the second connector, the other pivot being inserted in the third connecting hole of the third connector, the fastener being inserted in the first tightening hole of the first connector and the second tightening hole of the second connector.

6. The swing structure as claimed in claim 5, wherein the first tightening portion of the first connector protrudes from an inner plane of the first connector; the second tightening portion of the second connector protrudes from an inner plane of the second connector; one of the first tightening hole and the second tightening hole is provided with an internal thread corresponding to the fastener of the pivotably connecting unit.

7. The swing structure as claimed in claim 5, wherein the first connector and the second connector are arranged symmetrically; the first wing portion and the second wing portion form an accommodating space therebetween; one of a ratchet head and a handle of the ratchet wrench has a pivotably connecting block; the accommodating space is adapted for accommodating the pivotably connecting block; the pivotably connecting block is provided with a pivot hole.

8. The swing structure as claimed in claim 7, wherein one of the pivots of the pivotably connecting unit is inserted in the first connecting hole of the first connector, the pivot hole of the ratchet wrench, and the second connecting hole of the second connector.

9. The swing structure as claimed in claim 5, wherein one of a ratchet head and a handle of the ratchet wrench has two pivotably connecting blocks; the two pivotably connecting blocks form a pivotably connecting space therebetween; the third connector is accommodated in the pivotably connecting space; each of the pivotably connecting blocks is provided with a pivot hole.

10. The swing structure as claimed in claim 9, wherein one of the pivots of the pivotably connecting unit is inserted in one of the pivot holes of the ratchet wrench, the third connecting hole of the third connector, and the other pivot hole of the ratchet wrench.

11. The swing structure as claimed in claim 5, wherein the first connector, the second connector and the third connector are formed integrally.
